(19) United States
(12) Patent Application Publication
(10) Pub. No.: US 2010/0174784 A1
(43) Pub. Date: Jul. 8, 2010

(54) Systems and Methods for Analyzing Electronic Communications

(76) Inventors: Michael Ernest Levey, Birmingham (GB); Mark Alexander Neal, West Midlands (GB)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 11/991,674

(22) PCT Filed: Sep. 20, 2006
(86) PCT No.: PCT/GB2006/003496

§ 371 Date: Jan. 20, 2010

Related U.S. Application Data
(60) Provisional application No. 60/719,051, filed on Sep. 20, 2005.

(51) Int. Cl. G06F 15/16; G06F 15/173

(52) U.S. Cl. 709/206; 709/224

(57) ABSTRACT

Methods and systems are provided for analyzing e-mail communications. E-mail messages and/or associated information (e.g., senders, recipients, message IDs) communicated through an e-mail system are captured and analyzed to identify e-mail threads. Based on the e-mail threads, scores are generated that are indicative of e-mail usage of e-mail users. Based on the scores, an action may be performed such as, for example, notifying individual(s) or their manager(s) that e-mail user(s) are generating or initiating e-mail conversations that generate an excessive amount of e-mail traffic. As another example, the e-mail account of at least one user may be at least partially restricted based on the scores.

### CROSS-REFERENCE TO RELATED APPLICATION

This claims the benefit of U.S. Provisional Patent Application No. 60/719,051, filed Sep. 20, 2005, which is hereby incorporated by reference herein in its entirety.

### FIELD OF THE INVENTION

Embodiments of the present invention relate to systems and methods for analyzing electronic communications such as, for example, e-mail communications.

### BACKGROUND OF THE INVENTION

With the continued growth of electronic communication for corporate entities and other organizations (both internally and externally generated), corporations and employees are sending, receiving, processing, deleting and otherwise handling increasing numbers of e-mail messages. Some employees may receive more than 100 e-mails per day. The total time taken to review e-mail is now having an effect on employee productivity.

Employees frequently develop habits of copying e-mails to many recipients, regardless of whether the recipients have a real necessity to receive particular information. Not only does the time taken to handle these e-mails waste the recipients' time, but it can also mean that confidential and sensitive information is being distributed beyond those who have a requirement to have access to it. Trends have been observed in the increase in e-mail usage within companies (Osterman Research, 2006), which also equates to the growth in the unnecessary copying and forwarding of e-mails.

A large organization may have 50,000 or more active e-mail addresses and its employees will typically receive an average of between 40 and 80 e-mails per day, of which at least 20% typically are unnecessary copies and forwards and “replies to all”. Research done by the University of Loughborough and elsewhere in the USA (Clear Context 2006 E-mail Usage Survey), has shown that individuals spend a minimum of 24 seconds dealing with an e-mail. More typically the average amount of time spent is 1 minute 20 seconds.

This data demonstrates that within a large organization (about 50,000 active e-mail accounts) between 160,000 and 540,000 man days are lost each year, opening, reading, replying to and deleting unnecessary e-mails. The direct salary cost can equate to between $42 million USD and $137 million USD per annum in unproductive employee time, before considering any other overheads or cost apportionment.

Currently computer applications exist that determine working relationships within organizations by identifying senders and recipients of e-mails and other correspondence. Such examination is generally referred to as “Social Network Analysis”. In addition, there are also e-mail information systems available to index e-mails by subject, author, recipient, keyword and date/time for use in corporate compliance, where required by law (e.g. Sarbanes-Oxley Act), and text indexing tools.

However, there are presently no systems or methods for adequately monitoring electronic communications which may allow an organization to more readily identify individuals (e.g., those within an organization) who create a disproportionate amount of first and subsequent generations of e-mails.

### SUMMARY OF THE INVENTION

Some embodiments of the present invention are directed to systems and methods (embodied in software and/or hardware) for analyzing and monitoring the flow of electronic information between parties (e.g., individuals, companies, etc.). By analyzing the flow of e-mail traffic (for example) between individuals, and the interrelationships between originators, recipients and subsequent correspondents of e-mails and other electronically stored information within an organization, multiple generations of e-mails (as well as other documents) may be identified. In one particular embodiment, a result of the analysis identifies, for example, originators who create a disproportionate amount of first and subsequent generations of e-mails, and in doing so, reduce productivity of other individuals/employees. Some embodiments of the present invention may be used to generate reports for an organization's management, which can then implement and enforce internal corporate/organization communications policies. In other embodiments, other actions can be taken based on the analysis (e.g., automatically restricting or disabling users' e-mail accounts, or automatically sending an e-mail to users who generate an excessive amount of multigenerational e-mails).

Accordingly, in some embodiments of the present invention, a method for analyzing e-mail communications is provided in which e-mail messages and/or associated information (e.g., an e-mail message ID, e-mail address of sender, e-mail address(es) of recipients, attachment size, attachment type, and attachment content) communicated through an e-mail system are captured. For example, this capturing may include extracting the e-mail messages and/or associated information from an e-mail archive for the e-mail system. As another 10 example, the capturing may include receiving the e-mail messages and/or associated information in real time. The captured information may be analyzed to identify at least one e-mail thread, or the email thread can sometimes be automatically identified by email servers such as Microsoft Exchange Server. Based on the thread, at least one score indicative of e-mail usage of a given e-mail user may be generated. For example, analyzing the captured information may include iteratively analyzing a plurality of e-mail messages in order to identify relationships between senders and recipients of the e-mails over multiple e-mail generations. Generating at least one score may include generating a sub-score corresponding to each generation and determining the score based an the sub-scores.

In some embodiments, the method may further include performing an action based on the at least one score for the given user. For example, a report indicative of the at least one score may be generated. Such a report may include text, a graphic, animation, or a combination thereof and in some embodiments may be fixed or static on a computer or other display or printed on paper or other medium, in others the reports may be displayed interactively on a computer or other display and by selecting one or more items of the report or display such as text, graphic(s) or animation(s) or a combination thereof a report or display of information related to the item(s) selected, (for example) a particular e-mail thread, an e-mail address or group of e-mail addresses or e-mail content may be produced, which may include text, graphic(s) and/or animation(s). As another example, the action may include sending an e-mail alert to at least one user based on the at least one score (e.g., sending an alert to the given e-mail user or his/her supervisor). Still another example, the action may include at least partially restricting an e-mail account of the given user. As another example, the action may include comparing the score for the given e-mail user to a score for another e-mail user (e.g., a user from a different department in the same corporation or organization, from a different corporation or organization, from a different industry, or from a different region or country).

In still further embodiments of the present invention, an apparatus for analyzing electronic communications is provided that includes memory for storing e-mail messages and/or associated information communicated through an e-mail system. The apparatus also includes an e-mail analyzer configured to analyze the stored e-mail messages and/or associated information to identify linked or related e-mail communications as an at least one e-mail thread and to generate, based on the at least one e-mail thread, at least one score indicative of e-mail usage of a given e-mail user. In some embodiments, the apparatus may further include one or more e-mail servers configured to enable e-mail communication between a plurality of user computers, where the e-mail server or servers is/are configured to allow journaling, logging or other storage or archiving of the e-mail communications.

In still other embodiments, the information generated by embodiments of the present invention can be used to examine the working relationships between different departments or subsidiary companies. Some embodiments may additionally be used as a compliance tool to identify and examine communications containing (for example) specific keywords or phrases and also to identify specific communication links between individuals. Still other embodiments of the present invention are directed to computer readable media and computer application programs, application program interfaces (APIs) and graphic user interfaces (GUIs) for carrying out any of the above-noted embodiments (and other disclosed embodiments).

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a diagram of a system for analyzing electronic communications in accordance with various embodiments of the present invention;

FIG. 2 is a flowchart of illustrative stages involved in a method for analyzing electronic communications in accordance with various embodiments of the present invention;

FIG. 3 illustrates various levels of a corporation or other organization for which electronic communications can be analyzed and scores assigned in accordance with various embodiments of the present invention;

FIG. 4 is a flowchart of illustrative stages involved in mapping e-mails and associated information into threads in accordance with various embodiments of the present invention; and

FIG. 5 is a flowchart of illustrative stages involved in generating scores corresponding to usage of electronic communications in accordance with various embodiments of the present invention.

### DETAILED DESCRIPTION OF THE INVENTION

Some embodiments of the present invention relate to systems and methods for analyzing e-mail activity within a given computing environment (e.g., corporation or organization), to identify the particular e-mail user(s) (e.g., employees) that are responsible for initiating cascades of copied, forwarded, replies to all, and/or any other volume e-mail communications. For example, once identified these users can be notified automatically (e.g., via e-mail) that they are responsible for generating an excessive amount of e-mail correspondence. As another example, other individual(s) such as the managers of these users can be notified. Still another example, other actions can be taken such as restricting or disabling the e-mail accounts of the identified users or restricting the processing of specific or multiple e-mails. Various types of reports may be generated such as, for example, a ranked list of the 10% of employees who generate the largest volume of e-mail communications. Other reports may identify the employees who initiate the most multiple copy e-mails (including copies, forwards and replies to all) and/or who send e-mails (e.g., including confidential information) to other employees or recipients external to the corporation or organization that do not “need to know” the information based on their job function. By identifying the employees that waste significant amounts of other employees' time through the creation of volume e-mails and multigenerational emails, appropriate remedial action can be taken and productivity can be restored or improved within the workplace.

The information generated by embodiments of the present invention can also be used to examine the volume of e-mail communicated between members of the different departments and/or subsidiary companies of a given corporation or organization. Some embodiments may also be used as a compliance tool to identify and examine communications containing (for example) specific keywords or phrases. Such a compliance tool may be useful for use in, for example, enforcing confidentiality, secrecy and security policies of a corporate entity or other organization.

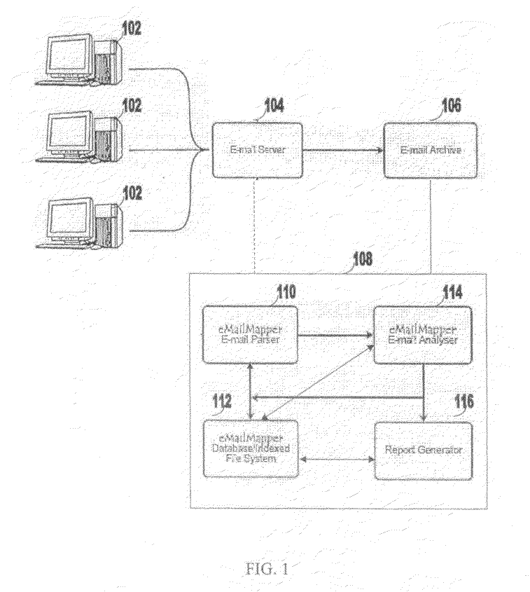

FIG. 1 is a diagram of a system 100 for analyzing electronic communications within a computing environment in accordance with various embodiments of the present invention. The computing environment may be, for example, a local area network (LAN) of a particular corporation or organization or any other suitable network or combination of networks. System 100 includes user computers 102, e-mail server or servers 104, and optionally e-mail archive 106. System 100 also includes apparatus 108, which includes e-mail parser 110 for parsing e-mails and/or related information, database/index file system 112 or other memory for storing and/or indexing the parsed information, e-mail analyzer 114 for analyzing the stored and/or indexed information, and report generator 116 for generating reports and/or triggering other actions based on the analysis. Apparatus 108 may include any suitable hardware, software, or combination thereof. For example, in some embodiments, apparatus 108 may be a standalone server or collection of servers capable of integrating with existing components 102, 104, and 106 within system 100. In other embodiments, some or all of the functions of apparatus 108 may be performed by server 104 and/or e-mail archive 106. For example, server 104 may be programmed with software for performing the respective functions of e-mail parser 110, e-mail analyzer 114, and report generator 116 described herein. In one particular embodiment, the functions of e-mail parser 110, e-mail analyzer 114, and report generator 116 may be performed by separate software modules within an overall software package.

E-mail server 104 enables e-mail communication between user computers 102. E-mail server 104 may be, for example, a Microsoft Exchange Server or any other suitable e-mail server. User computers 102 although shown in FIG. 1 as personal computers can be any suitable computing equipment for sending and/or receiving e-mail or other electronic communications including, for example, personal computers, personal digital assistants (PDAs), BlackBerry devices, any other computing device, and/or a combination thereof. In some embodiments, user computers may be connected to the same network (e.g., LAN or WAN) via a suitable wired or wireless connection(s) or optical connection(s) or a combination thereof. User computers 102 may be associated with, for example, individuals in the same corporation or organization. There may be multiple e-mail servers at one or more locations connected to the same network (e.g., LAN or WAN) via a suitable wired or wireless connection(s) or optical connection(s) or a combination thereof and many user computers in system 100, although only one e-mail server 104 and a few user computers 102 have been shown in FIG. 1 to avoid overcomplicating the drawing.

In some embodiments, system 100 may create an archive of e-mails and/or associated information. For example, when a network administrator enables a journaling configuration parameter on e-mail server 104, e-mail server 104 may send copies of (preferably) all e-mails that pass through server 104 and/or information associated with those e-mails to e-mail archive 106. E-mail archive 106 may be (for example) integrated as supplied or available as an addition to a software package of e-mail server 104. Preferably, e-mail archive 106 stores data in a standard format such as, for example, XML. The data archived for each e-mail may include some or all of the following: e-mail header information (e.g., including information from the “to”, “from”, “cc” and/or “bcc” fields); a message ID that uniquely identifies the message; message IDs for related messages; content from the e-mail body; e-mail attachments and/or information indicative of their file type and size; a time/date stamp indicating when the e-mail was routed through the server; and/or other information associated with electronic communications. The types of information stored by e-mail archive 106 may depend on, for example, whether system 100 is required to store such information (e.g., to comply with laws or regulations requiring such archiving by the organization) and/or the type of e-mail analysis that will be performed by e-mail analyzer 114. There may be multiple e-mail archives in system 100 although only one e-mail archive 106 has been shown in FIG. 1 to avoid overcomplicating the drawing. For example, in some embodiments, multiple e-mail archives may collect data from different departmental or site servers within a corporation or organization, or across two or more corporations or organizations. Data from these multiple archives may be used to produce a single consolidated or distributed database or databases or indexed or other type of file system 112 for analysis purposes.

Apparatus 108 may be configured to extract or otherwise receive e-mails and/or associated information communicated within system 100, in order to facilitate analysis of the communications and flow thereof. For example, in some embodiments, sets of information may be parsed by e-mail parser 110 from the archive(s) 106 of corporate/organization e-mails and/or other designated electronic information source(s), either automatically and/or under manual control. For example, such extraction may be performed through the use of analysis of e-mail threads according to originators, recipients, forwards, replies, replies to all, other header and/or body text information and/or attachment information and/or contents. The extraction may be performed continuously, periodically (e.g., hourly, daily, weekly, monthly, etc.), or with any other suitable/required frequency. The parsed information may be stored in database 112, which is preferably a relational database which may either be a configured as a single or multiple or distributed database(s), such as MySQL, Postgres or Microsoft SQL Server, or some, other form of indexed or other file system. In other embodiments, e-mails and associated information can be parsed by e-mail parser 110 and indexed in database 112 in real time as the e-mails pass through the organization's e-mail server(s) and/or other networked and inter-linked computers. This real-time processing is shown by the dotted line (communications link) between e-mail server 104 and apparatus 108 in FIG. 1. The parsed data may also be analyzed in real time by e-mail analyzer 114, which may allow for the real-time generation of reports and/or the triggering of other actions by report generator 116.

The information stored in database 112 may include some or all of the following: senders; recipients; copy recipients; forwards; replies; replies to all; receipt; display/read and deletion reports; e-mail body content; date/time; size; attachments; subject; other specified keywords and information; and/or relationships between the foregoing (e.g., information indicating which e-mails belong to the same thread). For example, in one embodiment, all body text for each e-mail and its associated information (e.g., sender, recipients, etc.) may be stored in database 112. E-mail attachments and/or associated information such as attachment size and type may or may not be stored. The type of information stored in database 112 and/or the period of time for which the information is stored may depend on, for example, configuration parameters set by a network administrator of system 100. For example, in some embodiments, a retention time limit may be set for information stored in database 112, and when this limit is reached for any record of information, it may be removed from the database and deleted or archived. The overall storage capacity required for index database 112 may depend on, for example, the way the configuration parameters are set within system 100 is configured and the level of e-mail traffic in system 100. When specific default configuration parameters are set (e.g., parameters requiring storage of all characters for each e-mail and no attachments), the storage required for database 112 may be relatively small compared to the total size of e-mail traffic within system 100. However, depending upon changes to the default configuration, the index database may need to accommodate storage of about 1 GB to 2 GB of information per day or more and in another embodiment database 112 may have a maximum storage capacity of 2,000 GB.

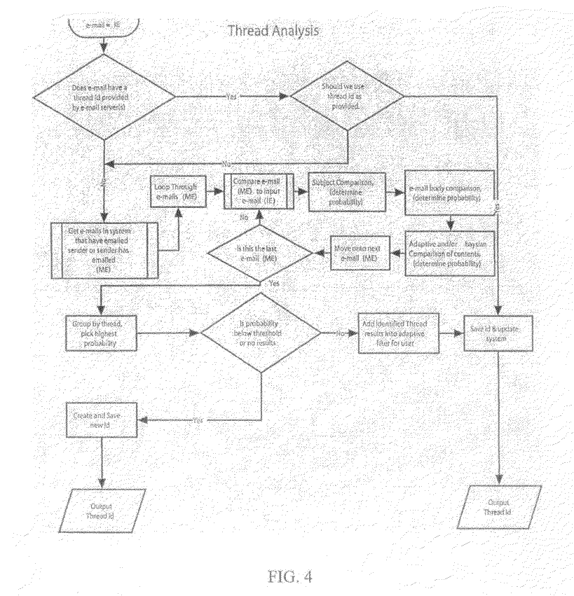

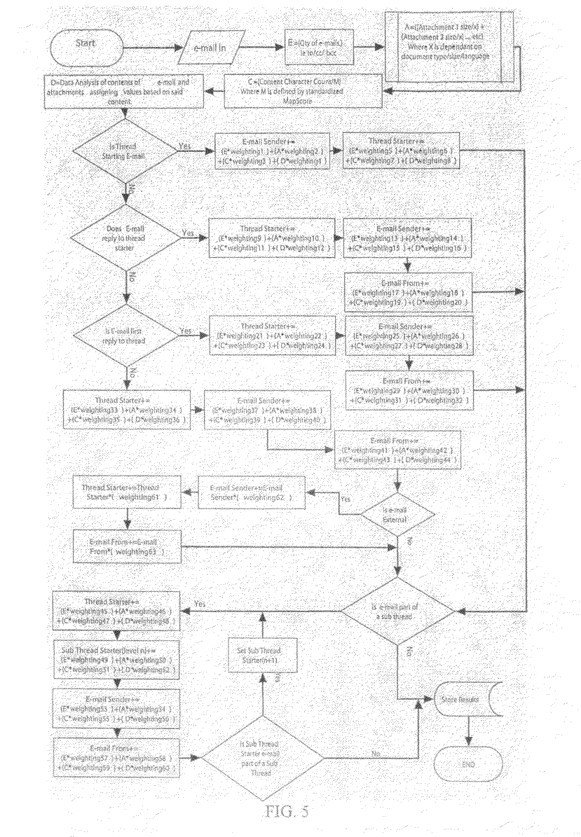

E-mail analyzer 114 may analyze information stored in database 112 (or processed in real-time) to, for example, identify sets of related e-mails referred to as “threads”. Identifying e-mail threads may be an iterative process that starts with an initial e-mail or item of data and follows/maps/analyzes/tracks through to subsequent and/or previous e-mails (e.g., based on e-mail IDs and/or other information) until entire sets of related e-mails have been identified (e.g., one set per e-mail thread). Mapping of e-mails and associated information into threads is described in greater detail below in connection with FIGS. 1 and 4. Upon completion of the thread analysis, e-mail analyzer 114 may assign a score (MapScore) which is combined into the relevant score for the reporting period for each user identified in the threads (the score for each user will be calculated individually for each email address in each thread) that is recognized within system 100, such as (for example) for each user having an e-mail address within a list of e-mail addresses stored in database 112, the scores may be based on information derived from the threads such as, for example, the number and type of e-mails (e.g., initial e-mails, replies to all, forwards, etc.) sent and received by the user, the type and size of any attachments to those e-mails, subsequent and/or previous generations of the e-mails, and/or other criteria. Generating scores that correspond to usage of electronic communications is described in greater detail below in connection with FIG. 5. Based on these scores, apparatus 108 and more specifically report generator 116 may generate a report and/or trigger other action(s). The reports generated may include any suitable media such as text, graphics, animation, audio, or a combination thereof and in some embodiments may be fixed or static on a computer or other display or printed on paper or other medium, in others the reports may be displayed interactively on a computer or other display and by selecting one or more items of the report or display such as text, graphic(s) or animation(s) or a combination thereof a report or display of information related to the item(s) selected, (for example) a particular e-mail thread, an e-mail address or group of e-mail addresses or e-mail content may be produced, which may include text, graphic(s) and/or animation(s). In a particular embodiment, report generator 116 may generate an e-mail to a network administrator or other individual(s) attaching a report (or link thereto) that identifies the particular user(s) who have created, either directly or indirectly, the most e-mail traffic in system 100. In another embodiment, report generator 116 may e-mail warnings to these particular users and/or at least partially disable their e-mail accounts or restricting the processing of specific or multiple e-mails.

In some embodiments, e-mail analyzer 114 and report generator 116 may perform other types of analysis or analyses and take other action(s) such as, for example, when apparatus 108 is used for compliance purposes (e.g., medical/healthcare systems compliance). For example, e-mail analyzer 114 may determine whether e-mails including confidential or other unauthorized information are being sent (or attempted) to person(s) unauthorized to receive such information. For medical/healthcare systems compliance (for example), such an analysis may be performed by checking whether sensitive data such as patient IDs or names are included in the e-mail text and/or determining whether the e-mail is being sent to e-mail(s) within a defined list of authorized e-mails (e.g., all e-mails associated with particular domain(s) and/or individual e-mail addresses). This analysis may be performed in real time so that report generator 116 can prevent e-mail server 104 from delivering non-conforming e-mails. Alternatively or additionally, report generator may generate a report indicative of all e-mails sent (or attempted) that disclose confidential information to unauthorized personnel, which report (for example) may be e-mailed to a network administrator or other individual(s) associated with system 100. When system 100 is used for compliance analysis, database 112 may include one or more storage devices (e.g., a disk farm) for storing the relatively large amount of data that can be required to be stored. Additionally apparatus 108 may be used in conjunction with other software which is capable of performing data mining and analysis.

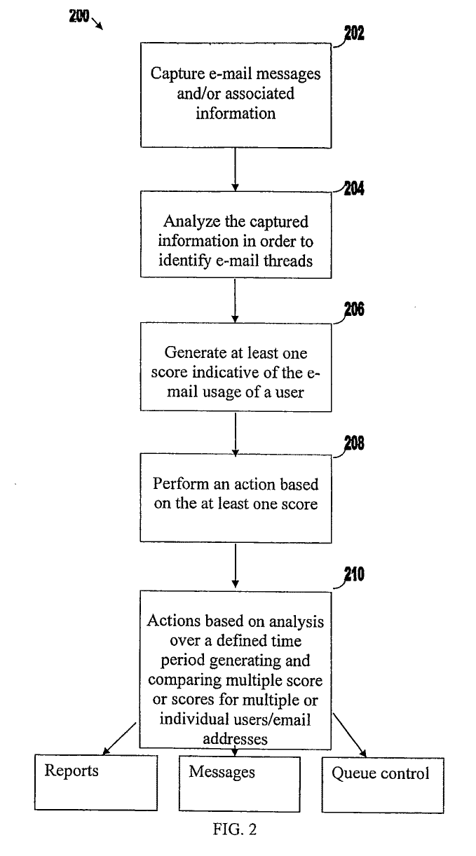

FIG. 2 is a flowchart 200 of illustrative stages involved in analyzing e-mail communications in accordance with an embodiment of the present invention. At stage 202, e-mail messages (and/or associated information) communicated through an e-mail system are captured. This capturing may involve, for example, extracting the information from an archive, extracting from a journal or from other log files, or receiving the information in a real-time flow of information. At stage 204, the captured e-mail messages and/or associated information is analyzed in order to identify e-mail threads. At stage 206, at least one score (MapScore) indicative of the e-mail usage of a given user is generated. At stage 208, an action is taken (e.g., a report generated normally over a predefined time period) based on the at least one score. At stage 210, additional actions may be performed such as (for example) generating reports for particular time periods and messages and/or queue management.

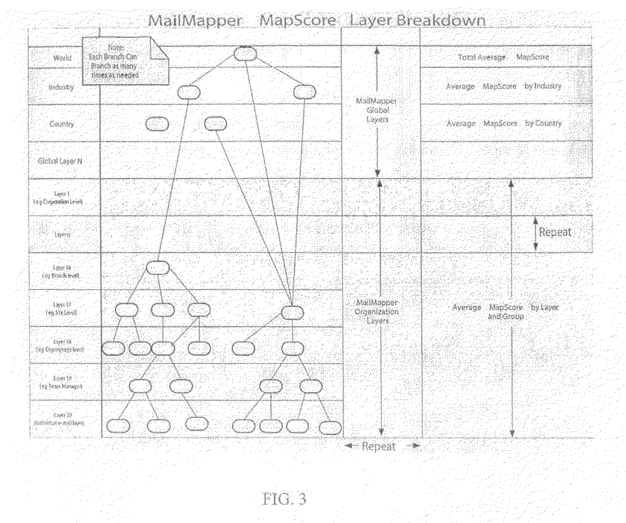

FIG. 3 illustrates various levels of a corporation or other organization for which electronic communications can be analyzed and scores assigned in accordance with various embodiments of the present invention. Illustrative corporate levels may include industry, country, branch, site, department, team manager(s), individual employees, and/or any other suitable corporate levels. Data indicative of the corporate structure may be stored in, for example, database 112 or other memory accessible to apparatus 108. In some embodiments, e-mails to and from all employees within a corporation that spans many locations and countries may be analyzed in order to assign a score to every individual in the corporation or other organization. Alternatively or additionally, a single, smaller group such as, for example, all e-mail addresses outside of a defined inner group (e.g., an inner group including the Company's President and Vice Presidents) may be defined for which e-mails are analyzed and scores assigned. In both examples, standardized scores may be generated by scoring the individuals based on the same criteria, irrespective of layer, country, industry, etc. Alternatively or additionally, scoring criteria for specific sub-group(s) (e.g., the human resources department) may be defined to allow for the generation of customized scores that take into consideration specific circumstances of the sub-group.

Regardless of whether standardized and/or customized scores are generated, statistics regarding the e-mail traffic generated by sub-groups can be (for example) compared or otherwise analyzed to allow the company to determine whether any given sub-group is causing relatively more than an acceptable amount of e-mail traffic. In some embodiments, individual, group and/or sub-group statistics for a corporation or other organization can be compared to (for example) statistics from other corporation(s) (e.g., corporations in the same or different industries based on SIC code, of the same or different size, in the same or different country, and/or based on any other logical grouping of organizations). To that end, at least a portion of the scores generated by apparatus 108 may be reported to a central repository for storing and analyzing scores for multiple organizations or parts of an organization. For example, a score for the organization comprising a sum of the scores for all individuals in the organization may be reported to the central repository. Scores across sub-groups of different organizations can also be combined in order to provide, for example, industry-wide or country-wide scores. Sub-group structuring in accordance with some embodiments of the present invention can also be used to simplify reporting, for example, reports for all employees associated with a particular sub-group can be sent to supervisor(s) for that sub-group.

In some embodiments, the analysis and generation of scores may also include analyzing and scoring external e-mails received by individual e-mail addresses or by groups and layers to identify which individual e-mail addresses or groups or layers of e-mail addresses are being targeted by the generators of external e-mails and to permit remedial action to be taken as or where appropriate within the corporation or organization. For example, each e-mail address in each and every thread will have a score associated with it. In the embodiment shown in FIG. 5, external mail is treated the same as normal mail, but a different weighting may be applied. This may allow reports to be produced showing which e-mail addresses are being targeted by specific external e-mails that are absorbing the most time/system resources in addition to volumes of incoming external e-mails. In some embodiments, the reports may be ordered by sender's domain, IP address or group of IP addresses, sender's e-mail address, or recipient's email addresses who have forwarded to other recipients within the organization or externally any received external e-mails. In addition, by analyzing all external e-mail it is possible to identify e-mail addresses outside of the corporation or organization that initiate e-mail communications that absorb a disproportionate amount of employee time, (for example) this may be an e-mail address or domain sending images, jokes, etc., that are forwarded or Spam or even technical correspondence that once received is widely dispersed within the corporation or organization.

FIG. 4 is a flowchart of illustrative stages performed by (for example) e-mail analyzer 114 (FIG. 1) in connection with mapping e-mails and associated information into threads in accordance with an embodiment of the present invention. With reference to FIG. 4, a chain of related e-mails (“thread”) including an identification of the originator of the thread can be identified by some or all of the following: thread markers (e.g., unique message IDs), an analysis of the body text to identify e-mails having the same topic or theme, header information, and/or attachments to e-mails. A thread ID is the unique identifier assigned to a series of e-mails which correspond to the content of one original e-mail, or other response e-mails to that same original e-mail. Some e-mail systems (e.g., Microsoft Exchange Server) will provide a thread ID upon collection of e-mail, and the e-mail analyzer 114 may use the thread ID if this option is pre-selected. The e-mail analyzer may also identify whether or not the incoming e-mail is part of an existing thread if no thread ID has been issued by the e-mail server. Where an e-mail has not previously been assigned a thread ID, the e-mail analyzer may analyze the e-mail and determine whether to assign the e-mail to the corresponding existing thread ID or to create a new thread ID and assign it to that one. The comparison function of the e-mail analyzer compares each incoming e-mail to e-mails sent or received by the recipient previously. It checks the contents of the respective e-mails (header information, body text of emails, attachments) for matches and compares previous replies to or received thread topics looking for trends in order to identify a possible match. Where a match is determined, this information may be fed back into the system so the system is able to adapt to the way the recipient replies to e-mails. This process enables the e-mail analyzer to improve the likelihood of its identification of the corresponding thread ID for a particular e-mail. In some embodiments, the e-mail analyzer may use Bayesian statistics, and in other embodiments it may use aggregation or other statistical techniques to facilitate and improve the likelihood of identification of the corresponding e-mail thread.

FIG. 5 is a flowchart of illustrative stages performed by (for example) e-mail analyzer 114 (FIG. 1) in connection with generating scores corresponding to usage of electronic communications in accordance with an embodiment of the present invention. As used in FIG. 5, “thread starter” refers to the e-mail address of the author of an e-mail that then garners a series of replies (the “thread”) responding to its content (or additional content or queries that develop during the ongoing email thread conversation). “E-mail thread” refers to a series of e-mails responding to the content of the original e-mail and/or other response e-mails to that same original e-mail. “E-mail sender” refers to the e-mail address of the author of the current e-mail or a subsequent and/or previous generation or generations thereof. “E-mail from” refers to the e-mail address of the sender of an e-mail to whom the current author (e-mail sender) is responding. “Sub thread” refers to part of an existing e-mail thread where one of the e-mail senders has included new participants (new e-mail addresses) and/or new topics related to the original starting e-mail, thus expanding the thread. “Sub thread starter” refers to the e-mail sender responsible for starting a sub thread. “MapScore” refers to a score or point value applied to individual e-mail addresses of thread starter, e-mail senders, e-mails from, sub thread starter and e-mail recipients and aggregates of thread starter, e-mail senders, e-mails from, sub thread starter and e-mail recipients representative of the man-hours consumed in dealing with e-mails generated or forwarded by them, weighted by their degree of participation in the generation and forwarding of the thread and various other factors.

As shown in FIG. 5, the process examines characteristics associated with an e-mail thread (e.g., number of e-mail recipients (E) including “to”, “cc”, and “bcc” recipients, attachment size (A), and body size (C) and content (D)), and assigns points to individual e-mail addresses according to those characteristics. The process also uses various weights to determine the relative effect each of the characteristics will have on the scoring, with different weights being assigned for e-mail senders, thread starter, e-mail from, sub-thread starter, and so on. The weights or points values may be allocated as pre-assigned defaults by the system and consist of two elements: the first element being representative of the time taken by the recipient of an e-mail to read and to respond to it and the second element being a point score that is skewed towards the e-mail address that initiates the most e-mails that develop into a thread of e-mail, or the e-mail address that forwards e-mails or enhances or modifies an e-mail and then replies to it or replies to all. In some embodiments, specific weights or points values may be customizable by a particular corporation or organization to suit its internal or other requirements. In other embodiments some possible variations on the system could allow the collected E, A, C, D to be analyzed by a central computing machine connected directly or indirectly to single or multiple e-mail analyzers, from which the machine may collect information, analys(es) and/or other relevant data to compare, re-analyze and feed back new weightings based on time-variant e-mail data and e-mail trends.

In some embodiments, the following scoring criteria may be used to assign scores to individuals: in the first generation, the thread starter is assigned 10+A+C points for each e-mail address entered in the “to”, “cc”, and “bcc” fields. In one embodiment, A may be equal to the number of attachments to the e-mail. In another embodiment, A may be equal to a number of points based on file size and/or type, such as 3 points per 100K of DOC file, 1 point per 100K of XLS file, 2 points per 50K of PDF file, and 1 point per JPG file. C may be based on the size of the e-mail body, such as 1 point per 1,000 characters.

In the second generation of e-mails, any user replying to and/or forwarding the e-mail from the first generation may be assigned 10+A+C points for each e-mail address entered in the “to”, “cc”, and “bcc” fields. The thread starter may also receive 5 points per e-mail address in the “to”, “cc” and “bcc” fields.

In the third generation of e-mails, any user replying to and/or forwarding the e-mail from the second generation may be assigned 10+A+C points for each e-mail address entered in the “to”, “cc”, and “bcc” fields. The thread starter may also receive 5 points per e-mail address in the “to”, “cc” and “bcc” fields. The user from the second generation that passed the e-mail on may also receive 5 points per e-mail address in the “to”, “cc” and “bcc” fields. In some embodiments this allocation of points may be restricted to pre-defined thread depth (multiple generations) n where n is any positive whole number and other embodiments this allocation of points may be restricted to a particular period of and/or specific e-mail addresses and/or specific groups and layers of e-mail addresses.

In some embodiments, an indication of the time wasted by e-mail recipients to read the e-mails may be assigned to e-mail originators and/or e-mail senders in subsequent generations. For example, for every 1,000 characters of an e-mail, the current sending user (and/or sender(s)/originator from prior generations) may be assigned a time value (e.g., T1) corresponding to an amount of time wasted for a recipient to read those 1,000 characters. The time value T1 may or may not be multiplied by the number of recipients of the e-mail. Alternatively or additionally, an indication (e.g.,) T2 of the time wasted by e-mail originators to create the e-mail messages (e.g., based on the number of characters and/or other criteria) may also be assigned to the e-mail originators and/or creators of sub-threads, and in some embodiments this may be expanded to include attachments created or read by senders and recipients.

Thus it is seen that systems and methods are provided for analyzing electronic communications. Although particular embodiments have been disclosed herein in detail, this has been done by way of example for purposes of illustration only, and is not intended to be limiting with respect to the scope of the appended claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implementable, at least in part, using a computer system, it will be appreciated that a computer program for implementing at least part of the described methods and/or the described systems is envisaged as an aspect of the present invention. The computer system may be any suitable apparatus, system or device, electronic, optical or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

We claim:

1. A method for analyzing e-mail communications comprising:
capturing e-mail messages and/or associated information communicated through an e-mail system;
analyzing the captured e-mail messages and/or associated information to identify at least one e-mail thread; and
based on the at least one e-mail thread, generating a score indicative of e-mail usage for a user involved in the e-mail thread.

2. The method of claim 1, wherein the generating comprises generating, for each e-mail user involved in the e-mail thread, a score indicative of e-mail usage.

3. The method of claim 1, wherein the score indicative of e-mail usage is based on one or more of an origination, forward, reply, and reply to all of e-mail(s) by the e-mail user.

4. The method of claim 3, wherein the score indicative of e-mail usage is further based on one or more of an e-mail forward, reply, and reply to all of a recipient of an e-mail sent by the e-mail user.

5. The method of claim 1, further comprising performing an action based on the score.

6. The method of claim 5, wherein the performing an action comprises generating a report indicative of the score.

7. The method of claim 6, wherein the generating a report comprises generating a report comprising text, a graphic, animation, or a combination thereof.

8. The method of claim 5, wherein the performing an action comprises sending an e-mail alert to at least one user based on the score.

9. The method of claim 5, wherein the performing an action comprises at least partially restricting an e-mail account of the e-mail user.

10. The method of claim 5, wherein the e-mail user is a member of a first group and performing an action comprises comparing the score for the e-mail user to a score for an e-mail user from a second group.

11. The method of claim 10, wherein said first group and said second group comprise different departments or other logical groupings in the same corporation or organization, different corporations or organizations, or different industries, regions, and/or countries.

12. The method of claim 1, wherein the capturing comprises extracting the e-mail messages and/or associated information from an e-mail archive or archives, journaling, log files, or other storage for the e-mail system.

13. The method of claim 1, wherein the capturing comprises receiving the e-mail messages and/or associated information in real time.

14. The method of claim 1, wherein the capturing comprises capturing at least one of: an e-mail message ID, e-mail address of sender, e-mail address(es) of recipients, attachment size, attachment type, attachment content, body content, e-mail header information, and associated e-mail information.

15. The method of claim 1, wherein the analyzing to identify at least one e-mail thread comprises iteratively analyzing a plurality of e-mail messages in order to identify relationships between senders and recipients of the e-mails over multiple e-mail generations.

16. The method of claim 15, wherein the generating the score for the e-mail user comprises assigning, for each e-mail user in the line of the e-mail thread and for all e-mails forwarded or replied to, weighting and/or points determining a sub-score based on where the e-mail user is in the thread and the actions the e-mail user actually initiated.

17. The method of claim 15, wherein the generating the score for the e-mail user comprises:
generating a first sub-score for the e-mail user based on an e-mail sent by the given user to one or more recipients;
generating one or more secondary sub-scores for the user based on at least one e-mail sent by the one or more recipients in subsequent and/or previous e-mail generation(s); and
determining the score based on the first sub-score and the one or more secondary sub-scores.

18. Apparatus for analyzing e-mail communications comprising:
memory for storing e-mail messages and/or associated information communicated through an e-mail system; and
an e-mail analyzer configured to:
analyze the stored e-mail messages and/or associated information to identify at least one e-mail thread; and
generate, based on the at least one e-mail thread, a score indicative of e-mail usage for an e-mail user involved in the e-mail thread.

19. The apparatus of claim 18, wherein the e-mail analyzer is configured to generate, for each e-mail user involved in the e-mail thread, a score indicative of e-mail usage.

20. The apparatus of claim 18, wherein the score indicative of e-mail usage is based on one or more of an origination, forward, reply, and reply to all of e-mail(s) by the e-mail user.

21. The apparatus of claim 20, wherein the score indicative of e-mail usage is further based on one or more of an e-mail forward, reply, and reply to all of a recipient of an e-mail sent by the e-mail user.

22. The apparatus of claim 18, wherein the apparatus is configured to perform an action based on the score.

23. The apparatus of claim 22, wherein the action comprises generating a report indicative of the score.

24. The apparatus of claim 22, wherein the action comprises sending an e-mail alert to at least one user based on the score.

25. The apparatus of claim 22, wherein the action comprises at least partially restricting an e-mail account of the e-mail user.

26. The apparatus of claim 18, wherein the memory stores e-mail messages and/or associated information extracted from an e-mail archive for the e-mail system.

27. The apparatus of claim 18, wherein the memory stores e-mail messages and/or associated information received in real time.

28. The apparatus of claim 18, wherein the e-mail messages and/or associated information comprises at least one of: an e-mail message ID, e-mail address of sender, e-mail address(es) of recipients, attachment size, attachment type, attachment content, and body content, e-mail header information, and associated e-mail information.

29. The apparatus of claim 18, wherein the e-mail analyzer is configured to identify the at least one e-mail thread by iteratively analyzing a plurality of e-mail messages in order to identify relationships between senders and recipients of the e-mails over multiple e-mail generations.

30. The apparatus of claim 18, wherein the e-mail analyzer is configured to:
generate a first sub-score for the e-mail user based on an e-mail sent by the e-mail user to one or more recipients;
generate one or more secondary sub-scores for the e-mail user based on at least one e-mail sent by the one or more recipients in subsequent and/or previous e-mail generation(s); and
determine the at least one score based on the first sub-score and the one or more secondary sub-scores.

31. The apparatus of claim 18, further comprising:
a plurality of user computers; and
an e-mail server or servers for enabling e-mail communications between the plurality of user computers, wherein the e-mail server or servers is/are configured to allow journaling, logging or otherwise storage or archiving of the e-mail communications.

32. A system for analyzing e-mail communications comprising:
means for capturing e-mail messages and/or associated information communicated through an e-mail system;
means for analyzing the captured e-mail messages and/or associated information to identify at least one e-mail thread; and
means for generating, based on the at least one e-mail thread, a score indicative of e-mail usage of an e-mail user.
